(19) United States
(12) Patent Application Publication
(10) Pub. No.: US 2021/0140682 A1
(43) Pub. Date: May 13, 2021

(54) DUST REMOVAL DEVICE FOR SOLAR PANEL

(71) Applicant: Ningxia University, Yinchuan City (CN)

(72) Inventors: Xingcai LI, Yinchuan City (CN); Guoqing Su, Yinchuan City (CN); Cai Kang, Yinchuan City (CN); Juan Wang, Yinchuan City (CN)

(21) Appl. No.: 17/083,277

(22) Filed: Oct. 28, 2020

(30) Foreign Application Priority Data
Nov. 6, 2019 (CN) 201911075007.9

(51) Int. Cl. F24S 40/20; B64D 1/22

(52) U.S. Cl. CPC F24S 40/20; B64D 1/22

(57) ABSTRACT

The disclosure provides a dust removal device for a solar panel. The dust removal device includes a first track and a second track, arranged on two sides of the solar panel; worms, connected with the first track and the second track; an ultrasonic vibration device, fixed to a stepper motor on a framework which can move along the worms to enable the ultrasonic vibration device to swing left and right; a hair brush, fixed on the framework and configured to move in the direction of the worms; a fan, fixed to the framework which can move along the worms, blowing away dust brushed by the hair brush; and an ultrasonic sensor, configured to detect a distance between the framework and the first track or the second track, and enabling the framework to return to the first track or the second track when the distance is smaller than a preset threshold.

### TECHNICAL FIELD

The disclosure relates to the field of machinery, in particular to a dust removal device for a solar panel.

### BACKGROUND

At present, dust on a solar panel has great influence on solar energy electricity generation in China, and a solar panel of 180 watt is taken as an example. Through test, when coverage amount of dust on the surface of the solar panel reaches 4.05 gram/square meter, electricity generation capacity can be reduced by about 40%, equivalent to reduction of electricity generation power by 72 watts, i.e., actual available power only remains 108 watts, which is far lower than that of a battery panel of 180 watts with a dust removal device for a solar panel disclosed by the invention.

Two traditional methods for removing dust on the surface of the solar panel include a method for flushing the solar panel with water, which can consume massive human resources and water resources and can only be applied to solar panels mounted at low positions, such as a solar lawn lamp and a solar floor lamp, and for the solar panels mounted at high positions, such as a solar street lamp and a rooftop solar electricity supply device, the method is inconvenient for dust removal; and a method for removing dust on the surface of the solar panel through a pneumatic device, the pneumatic device is complex in structure and poor in reliability, the solar panel can be damaged due to misoperation, initial investment and later-stage maintenance cost are high, and electricity generation cost is greatly increased, so that the method is difficult to popularize and apply.

It can be seen that the existing dust removal device needs massive water resources and human resources, the solar panel is generally mounted at arid regions and high mountain regions, water is difficult to obtain, and cost is high. In addition, the solar panel is limited in bearing capacity, and the existing dust removal device is so heavy that the solar panel can be damaged during working. Furthermore, the existing dust removal device does not have a sand prevention function, so that the dust removal device cannot work after working for some time and is poor in reliability. After sweeping a group of solar panels, a dust removal robot is inconvenient to move, so that it is difficult to clean another group of solar panels.

### SUMMARY

An objective of the disclosure is to provide a dust removal device for a solar panel. Dust adsorbed on the solar panel and substances difficult to wipe are subjected to ultrasonic vibration and are cleared away by a hair brush, and finally, a fan blows away the dust brushed by the hair brush. After the dust removal device cleans a group of solar panels, a mechanical claw mounted on an aircraft conveys a dust removal robot from a thoroughly cleaned solar panel to a solar panel which is not cleaned.

The disclosure provides a dust removal device for a solar panel. The dust removal device includes a first track and a second track, arranged on two sides of the solar panel; worms, connected with the first track and the second track, extending in a direction perpendicular to the first track and the second track, and moving relative to the first track and the second track through a first drive mechanism; an ultrasonic vibration device, fixed to a stepper motor on a framework which can move along the worms; a hair brush, fixed to the framework and configured to move in the direction of the worms and clean the solar panel through a second drive mechanism; a fan, fixed to the framework which can move along the worms; and an ultrasonic sensor, configured to detect a distance between the framework and the first track or the second track, and enabling the framework to return to the first track or the second track when the distance is smaller than a preset threshold (such as 5 cm). For example, when departing from the first track, the framework returns to a position on the side of the first track. An aircraft conveying device includes a mechanical claw, a camera and an aircraft, where the mechanical claw is fixed to a bottom of the aircraft and conveys a dust removal robot through grippers on the dust removal device; and the camera is fixed to the center of the bottom of the aircraft and is perpendicular to the ground downwards, and wireless communication equipment transmits images shot by the camera onto a screen of a control console.

In the dust removal device, the first drive mechanism and the second drive mechanism include motors.

In the dust removal device, the hair brush and the fan are configured to clean the solar panel treated by the ultrasonic vibration device.

The dust removal device also includes gears fixed to the worms or the first track and the second track to promote the worms to move on the first track and the second track.

The dust removal device also includes the aircraft conveying device for positioning the worms and the framework to another solar panel.

In the dust removal device, the gear includes a driving wheel and a driven wheel which are respectively fixed to the worms and the first track and the second track.

In the dust removal device, the aircraft conveying device includes the camera, the mechanical claw and the aircraft, where the camera determines whether the driving wheel and the driven wheel are on the first track and the second track or not, and the mechanical claw grasps the grippers on the dust removal device for conveying a dust removal robot.

Dust adsorbed on the solar panel and substances difficult to wipe are subjected to ultrasonic vibration and are cleared away by the hair brush, and finally, the fan blows away dust brushed by the hair brush. After the dust removal device cleans a group of solar panels, the robot is accurately conveyed through the mechanical claw mounted on the aircraft and the camera, from a thoroughly cleaned solar panel to a solar panel which is not cleaned.

### BRIEF DESCRIPTION OF THE DRAWINGS

FIG. 1 shows a top view of a structure of a dust removal robot.

FIG. 2 shows a side view of the structure of the dust removal robot.

FIG. 3 shows an upper right rear view of the structure of the dust removal robot.

FIG. 4 shows a circuit of an ultrasonic distance measuring sensor which is mounted under a dust removal robot and measures a movement distance of the dust removal device to a position under the solar panel.

FIG. 5 shows an electricity supply circuit providing an electric source for a sensor, a control panel and a 4G communication module.

FIG. 6 shows a circuit of an MSP430 controller which controls motors and an ultrasonic vibration device to work normally and is connected with the ultrasonic distance measuring sensor for measuring data.

FIG. 7 shows a 4G module circuit, where one end of the 4G module circuit is connected to the electric source in FIG. 5 through a lead wire, and the other end connects UART RXD/UART TXD in FIG. 7 with TXD/RXD of a single-chip microcomputer in FIG. 6 through a lead wire for data transmission.

FIG. 8 shows a top view of an aircraft conveying device.

FIG. 9 shows a front view of the aircraft conveying device.

FIG. 10 shows a side view of the aircraft conveying device.

### DETAILED DESCRIPTION

The following examples provide a more comprehensive understanding of the disclosure to those skilled in the art, and are not intended to limit the disclosure in any way.

FIG. 1 shows the top view of a structure block diagram of a dust removal robot, where 1 represents an upper aircraft conveying gripper, 2 represents a No. 3 motor, 4 represents a hair brush, 3 represents a No. 2 motor, 5 represents a pinion, 6 represents first-stage speed reduction structure, 7 represents an upper side driven wheel, 9 represents an upper track driven wheel, 8, 21 and 25 represent pinions, 10 and 19 represent worms, 11 represents a lower track driven wheel, 13 represents a lower side driven wheel, 12 represents an ultrasonic sensor, 14 represents a lower aircraft conveying gripper, 15 represents a lower side driven wheel, 16 represents a lower track driving wheel, 17 represents a lower track, 18 represents a solar panel, 20 represents an ultrasonic vibration device, 22 represents an upper track driving wheel, 23 represents an upper track, 24 represents a driving wheel motor, 26 represents a No. 1 motor, 27 represents a stepper motor, and 28 represents a fan. If the dust removal robot is too heavy, the dust removal robot can crush the solar panel when working on the solar panel, so that tracks are singly manufactured. The driving wheels and the driven wheels in upper and lower tracks guarantee the robot to move straightly, and the upper side driven wheel and the lower side driven wheel mainly fix the robot on the solar panel so that the robot does not drop off when working on the inclined solar panel. The hair brush, the fan and the ultrasonic vibration device are combined to form the dust removal device. The driving wheel motor controls the dust removal robot to move left and right. The NO. 1 motor and the No. 2 motor are connected with the worms to control the worms to rotate. Four pinions on the dust removal device are engaged with the worms to control the dust removal device to move up and down. The No. 3 motor drives the hair brush to rotate quickly to clean dust through a first-stage accelerating structure (a bull gear drives one pinion to rotate, a shaft of the bull gear is connected with the corresponding motor, and a shaft of one pinion is connected with the hair brush). After cleaning a group of the solar panels, the dust removal robot is conveyed to another group of the solar panels in a manner that a mechanical claw on an aircraft grasps aircraft conveying grippers on two sides of the dust removal robot.

FIG. 2 shows a side view of the structure of the dust removal robot. FIG. 3 shows an upper right rear view of the structure of the dust removal robot. FIG. 4 shows a circuit of an ultrasonic distance measuring sensor which is mounted under the dust removal robot and measures a movement distance of the dust removal device to a position under the solar panel. FIG. 5 shows an electricity supply circuit providing an electric source for a sensor, a control panel and a 4G communication module. FIG. 6 shows a circuit of an MSP430 controller which controls motors and an ultrasonic vibration device to work normally and is connected with the ultrasonic distance measuring sensor for measuring data. FIG. 7 shows a 4G module circuit, where one end of the 4G module circuit is connected to the electric source in FIG. 5 through a lead wire, and the other end connects UART RXD/UART TXD in FIG. 7 with TXD/RXD of a single-chip microcomputer in FIG. 6 through a lead wire for data transmission. FIG. 8 shows a top view of an aircraft conveying device. FIG. 9 shows a front view of the aircraft conveying device. 27 represents a camera, 28 represents a mechanical arm and 29 represents a mechanical claw. In a conveying process, the camera observes whether the mechanical claw grasps the conveying grippers of the dust removal robot or not, when the dust removal robot is put on a group of new solar panels, the camera observes whether the driving wheels and the driven wheels on and under the dust removal robot enter the tracks or not, if not, the position of the aircraft is adjusted, if yes, the mechanical claw of the aircraft loosens the grippers of the dust removal robot, and then the dust removal robot continues working.

FIG. 10 shows a side view of the aircraft conveying device. 30 represents an active linkage shaft, and 31 represents a mechanical claw angle adjusting device. The active linkage shaft mainly functions to connect the mechanical arm and the mechanical claw. For the mechanical claw angle adjusting device, the bull gear is mounted on a mechanical claw, a motor and a pinion are mounted on the mechanical arm, the pinion is engaged with the bull gear, and the motor controls the angle of the mechanical claw.

The driving wheel motor, the No. 1 motor and the NO. 2 motor adopt stepper motors, and the No. 3 motor adopts a DC motor. The mechanical claw angle adjusting device uses the stepper motor.

Through design of the dust removal device for a solar panel disclosed by the disclosure, a driving motor controls the dust removal robot to move from left to right on the solar panel, and the No. 1 motor and the No. 2 motor control the dust removal device to move from top to bottom on the solar panel. When the dust removal device reaches a position under the solar panel and when the ultrasonic sensor detects that the dust removal device reaches a certain distance, the dust removal device stops and returns to an upper initial position, and at the same time, the dust removal robot moves leftwards for a certain distance. After cleaning a group of solar panels, the dust removal robot transmits information to a front end worker through 4G communications. The worker controls the aircraft to reach a position above the dust removal robot, and adjusts the angle of the aircraft conveying device and the angle of the mechanical claw through the camera. Then the mechanical claw hooks the conveying grippers on the dust removal robot, and the dust removal robot is conveyed. When the dust removal robot is put on a group of solar panels, whether the driving wheels and the driven wheels on the dust removal robot are in the tracks or not is observed through the camera, if not, the angle of the aircraft conveying device is adjusted, if yes, the angle of the mechanical claw is controlled, and the dust removal robot is loosened to continue working.

The dust removal device clears away dust and the like on the solar panel through the hair brush after ultrasonic vibration, and finally blows away the dust brushed by the hair brush through the fan. An aircraft conveying device includes a mechanical claw, a camera and an aircraft, where the mechanical claw is fixed to a bottom of the aircraft and conveys the dust removal robot through grippers on the dust removal device; and the camera is fixed to the center of the bottom of the aircraft and is perpendicular to the ground downwards, and wireless communication equipment transmits images shot by the camera onto a screen of a control console; after a group of solar panels are cleaned, the aircraft is controlled to reach a position above the dust removal device, through images transmitted back by the camera on the aircraft, the mechanical claw on the aircraft is controlled to accurately grasp the grippers on the dust removal device, and the dust removal device moves to a position above the tracks of the solar panel which is not cleaned; and according to the images, the worker observes whether four wheels of the dust removal device totally enter the tracks or not, after the four wheels enter the tracks, the mechanical claw on the aircraft is controlled to loosen the grippers on the dust removal device, and then the dust removal device continues working.

Those skilled in the art should appreciate that the foregoing examples are merely exemplary examples, and various changes, substitutions and changes can be made without departing from the spirit and scope of the present application.

What is claimed is:

1. A dust removal device for a solar panel, comprising
a first track and a second track, arranged on two sides of the solar panel;
worms, connected with the first track and the second track, extending in a direction perpendicular to the first track and the second track, and moving relative to the first track and the second track through a first drive mechanism;
an ultrasonic vibration device, fixed to a stepper motor on a framework which can move along the worms, and driven by the stepper motor to swing left and right;
a hair brush, fixed to the framework and configured to move in the direction of the worms and clean the solar panel through a second drive mechanism;
a fan, fixed to the framework which can move along the worms, and blowing away dust brushed by the hair brush; and
an ultrasonic sensor, configured to detect a distance between the framework and the first track or the second track, and enabling the framework to return to the first track or the second track when the distance is smaller than a preset threshold.

2. The dust removal device according to claim 1, wherein the first drive mechanism and the second drive mechanism comprise motors.

3. The dust removal device according to claim 1, wherein the hair brush and the fan are configured to clean the solar panel treated by the ultrasonic vibration device.

4. The dust removal device according to claim 1, wherein the dust removal device also comprises gears fixed to the worms or the first track and the second track to promote the worms to move on the first track and the second track.

5. The dust removal device according to claim 4, wherein the dust removal device also comprises an aircraft conveying device for positioning the worms and the framework to another solar panel.

6. The dust removal device according to claim 4, wherein the gears comprise a driving wheel and a driven wheel which are respectively fixed to the worms and the first track and the second track.

7. The dust removal device according to claim 6, wherein the aircraft conveying device comprises a camera, an aircraft and a mechanical claw, the camera determines whether the driving wheel and the driven wheel are on the first track and the second track or not, and the mechanical claw grasps grippers on the dust removal device for conveying a dust removal robot.
